(19) United States
(12) Patent Application Publication
(10) Pub. No.: US 2022/0405464 A1
(43) Pub. Date: Dec. 22, 2022

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Takenori MATSUO, Kanagawa (JP)

(73) Assignee: FUJIFILM Business Innovation Corp., Tokyo (JP)

(21) Appl. No.: 17/531,782

(22) Filed: Nov. 21, 2021

(30) Foreign Application Priority Data
Jun. 18, 2021 (JP) 2021-101756

(51) Int. Cl. G06F 40/166; G06F 3/0482; G06F 3/0483; G06F 16/93

(52) U.S. Cl. CPC G06F 40/166; G06F 3/0482; G06F 3/0483; G06F 16/93

(57) ABSTRACT

An information processing apparatus includes a processor configured to receive an area in a document from a first user and set in the received area an exclusive area that is not editable by a user other than the first user.

### CROSS-REFERENCE TO RELATED APPLICATIONS

This application is based on and claims priority under 35 USC 119 from Japanese Patent Application No. 2021-101756 filed Jun. 18, 2021.

### BACKGROUND

### (i) Technical Field

The present invention relates to an information processing apparatus, a non-transitory computer readable medium storing a program, and an information processing method.

### (ii) Related Art

As a document editing function, there is a document creation tool having a function of simultaneously editing a document by a plurality of users in real time, such as a Google (registered trademark) document. With such a document creation tool, one document can be edited by the plurality of users at the same time, and thus the edit can proceed efficiently. On the other hand, the edit by the plurality of users may conflict.

There is content management software such as DocuShare that has a function of checking in/checking out the document and temporarily prohibiting another user from editing the document. With the use of the content management software, there is no edit conflict by the plurality of users for one document. However, in a case where one person monopolizes the document for a long period of time, another user cannot edit the document during the time.

Examples of the related art include JP2008-165299A.

### SUMMARY

Aspects of non-limiting embodiments of the present disclosure relate to an information processing apparatus, a non-transitory computer readable medium storing a program, and an information processing method that efficiently perform a simultaneous edit by a plurality of users on a document while preventing editing conflicts between the users in a document, as compared with a case where a user is not allowed to set an area that is not editable by another user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to receive an area in a document from a first user and set in the received area an exclusive area that is not editable by a user other than the first user.

### BRIEF DESCRIPTION OF THE DRAWINGS

Exemplary embodiment(s) of the present invention will be described in detail based on the following figures, wherein:

FIG. 1 is a block configuration diagram of a document management system according to the present exemplary embodiment;

FIGS. 2A and 2B are diagrams showing a display example of an edit screen displayed on each user terminal apparatus in the present exemplary embodiment;

FIGS. 3A and 3B are diagrams showing a display example of an edit screen displayed on each user terminal apparatus in the present exemplary embodiment and are diagrams showing an example of screens displayed following FIGS. 2A and 2B;

FIG. 4 is a sequence diagram showing an exchange of data and an instruction or a request in a case where an edit is performed between a document management server and each user terminal apparatus in the present exemplary embodiment;

FIGS. 5A and 5B are diagrams showing a display example of an edit screen displayed on each user terminal apparatus in the present exemplary embodiment and are diagrams showing another example of screens displayed following FIGS. 2A and 2B;

FIGS. 6A and 6B are diagrams showing a display example of an edit screen displayed on each user terminal apparatus in the present exemplary embodiment and are diagrams showing another example of screens displayed following FIGS. 3A and 3B;

FIGS. 7A and 7B are diagrams showing a display example of an edit screen displayed on each user terminal apparatus in the present exemplary embodiment and are diagrams showing an example of screens displayed following FIGS. 6A and 6B;

FIGS. 8A and 8B are diagrams showing another example relating to setting of an exclusive area in the present exemplary embodiment;

FIG. 9 is a diagram showing an example of a list display screen of a plurality of pages constituting a document according to the present exemplary embodiment; and

FIG. 10 is a diagram showing another example of the list display screen of the plurality of pages constituting the document according to the present exemplary embodiment.

### DETAILED DESCRIPTION

Hereinafter, exemplary embodiments of the present invention will be described based on drawings.

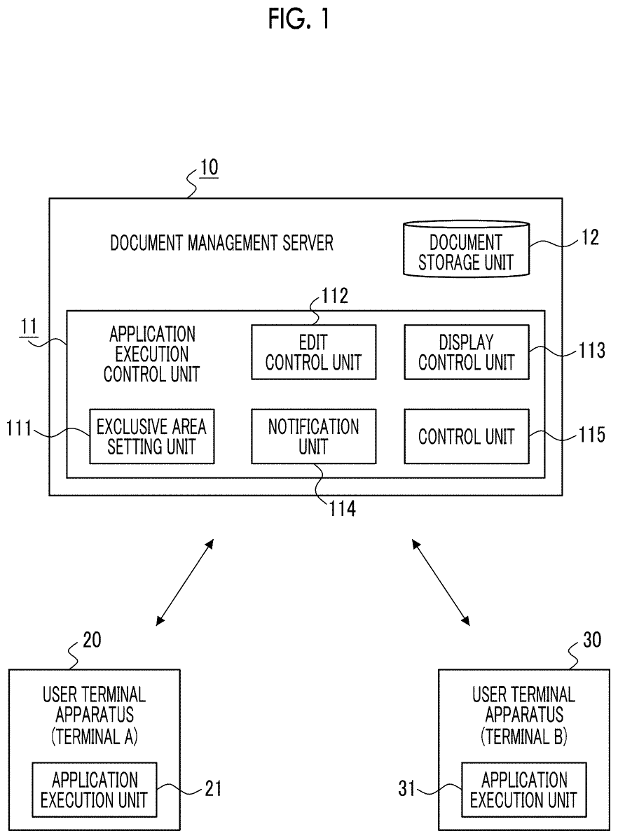

FIG. 1 is a block configuration diagram of a document management system according to the present exemplary embodiment. The document management system according to the present exemplary embodiment is a system that manages a document created by a user, and has a function of supporting edit processing of an existing document by the user, as described in detail below.

FIG. 1 shows a document management server 10 and user terminal apparatuses 20 and 30. The document management server 10 and the user terminal apparatuses 20 and 30 exchange information related to the document via a network (not shown). The network is not particularly limited and may be a local area network (LAN), the Internet, or a combination thereof. The information is exchanged in a state where security is ensured by a virtual private network (VPN) or the like as necessary.

The document management server 10 corresponds to an information processing apparatus according to the exemplary embodiment of the present invention. In the present exemplary embodiment, the information processing apparatus according to the exemplary embodiment of the present invention is formed by a server computer. The document management server 10 according to the present exemplary embodiment can be formed by a hardware configuration of the general-purpose server computer that exists in the past. That is, the document management server 10 has a CPU, a ROM, a RAM, a hard disk drive as storage means, and a network interface as communication means. The document management server 10 may have a user interface including an input means, such as a mouse or a keyboard, and display means, such as a display, as necessary.

The document management server 10 according to the present exemplary embodiment has an application execution control unit 11 and a document storage unit 12. A component not used in the description of the present exemplary embodiment is omitted from FIG. 1. The application execution control unit 11 controls the execution of an application having a function of editing, browsing, or the like the document executed by the user terminal apparatuses 20 and 30. The document storage unit 12 stores the document to be processed such as the edit by the user terminal apparatuses 20 and 30.

The application execution control unit 11 includes an exclusive area setting unit 111, an edit control unit 112, a display control unit 113, a notification unit 114, and a control unit 115. The exclusive area setting unit 111 sets an area designated by the user who edits the document as an exclusive area that is not editable by a user other than the user. The exclusive area is automatically set depending on a condition. The edit control unit 112 controls the edit of the document. The display control unit 113 controls the display of the document on the user terminal apparatuses 20 and 30. The notification unit 114 transmits a message to the user terminal apparatuses 20 and 30 to display the message on a screen, under the display control by the display control unit 113. With the display of the message on the screen, for example, the user is notified of occurrence of an event related to the setting of the exclusive area, cancellation of the setting of the exclusive area, and the like. The control unit 115 controls the execution of the application executed by the user terminal apparatuses 20 and 30 in cooperation with the respective components 111 to 114 to control the browsing or edit of the document by users of the user terminal apparatuses 20 and 30.

The application execution control unit 11 in the document management server 10 is formed by a cooperative operation of a computer forming the document management server 10 and a program operating on a CPU mounted on the computer. The document storage unit 12 is formed by an HDD mounted on the document management server 10. Alternatively, a RAM or external storage means may be used through a network.

The user terminal apparatuses 20 and 30 are information processing apparatuses used for browsing, editing, and the like the document managed by the document management server 10. The user terminal apparatuses 20 and 30 according to the present exemplary embodiment can be formed by a general-purpose hardware configuration that exists in the past, such as a personal computer (PC). That is, the user terminal apparatuses 20 and 30 include the CPU, the ROM, the RAM, the hard disk drive as the storage means, the network interface provided as the communication means, and the user interface including the input means, such as the mouse or the keyboard, and the display, such as the display means.

Both the user terminal apparatuses 20 and 30 have application execution units 21 and 31. The application execution units 21 and 31 execute an application having a function for browsing and editing the document managed by the document management server 10. This application is controlled by the application execution control unit 11 in the document management server 10. The user terminal apparatuses 20 and 30 basically have the same configuration. In the present exemplary embodiment, a user A uses the user terminal apparatus 20, and a user B uses the user terminal apparatus 30. In the following description, in a case where the user terminal apparatus 20 is described individually, the user terminal apparatus 20 is described as “terminal A”. In a case where the user terminal apparatus 30 is described individually, the user terminal apparatus 30 is described as “terminal B”.

Next, an operation in the present exemplary embodiment will be described.

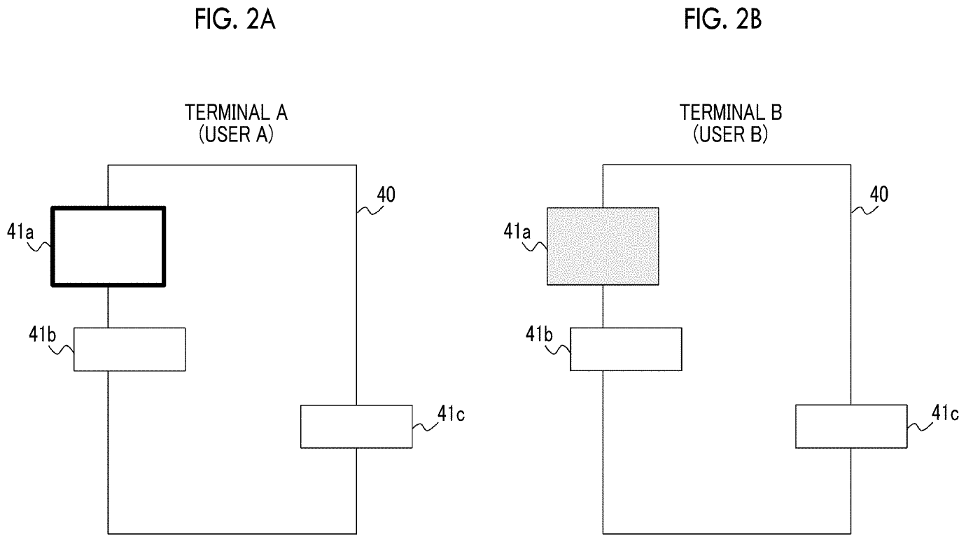

FIGS. 2A and 2B are diagrams showing a display example of an edit screen displayed on each of the user terminal apparatuses 20 and 30. First, a basic operation of the present exemplary embodiment will be described with reference to FIGS. 2A and 2B.

FIG. 2A is a display example of the edit screen on the terminal A, and FIG. 2B is a display example of the edit screen on the terminal B. Similarly, in the screen display example used in the following description, (a) is the display example of the terminal A, and (b) is the display example of the terminal B. In FIGS. 2A and 2B, in order for the user A to edit a document 40, the terminal A acquires the document 40 to be edited from the document management server 10 and displays the document on the screen. For the sake of simplification of the description, the document 40 is assumed to be composed of one page. Three sticky notes 41a, 41b, and 41c are added to the document 40.

In the following description, in a case where there is no need to distinguish the sticky notes 41a, 41b, and 41c from each other, the sticky notes are collectively referred to as “sticky note 41”. In FIGS. 2A and 2B, a rectangular-shaped area indicated by the sticky note 41 is an additional area for displaying additional information to the document 40. The sticky note 41 is added to the document 40 by the function of the application executed by the application execution units 21 and 31. In the present exemplary embodiment, the sticky note 41 is described as an example of the additional area, but the present exemplary embodiment is not limited to the sticky note 41. In a case where the term “document” is used, the additional area of the document is also included in the “document” unless otherwise specified. Therefore, the edit target in the case of “editing document” includes not only a page in which a body of the document is described but also the additional area.

In a case where the user A wants to edit the description content of the sticky note 41a, the user A designates the sticky note 41a to be edited by a predetermined operation. That is, an area designated as an edit range by the user A is equal to a display area of the sticky note 41a.

As a method of designating the area to be edited, for example, the sticky note 41a may be right-clicked. Alternatively, a shortcut menu displayed by the right-clicking may include “edit” and the user may select “edit”. Alternatively, the document 40 may be switched to an edit mode for performing the edit, and then the sticky note 41a to be edited may be selected. The method of designating the area to be edited as exemplified here is only an example, and the user may designate the area to be edited by the method exemplified here or another method.

In a case where the application execution control unit 11 in the document management server 10 receives an edit area, that is, the area specified by the sticky note 41a from the user A in response to the predetermined operation, the exclusive area setting unit 111 sets the designated area (that is, sticky note 41a) as the exclusive area that is not editable by the user other than the user A. Information about the setting of the exclusive area is stored in the document storage unit 12. The exclusive area that is editable only by a certain user, the user A in this example, is referred to as an “exclusive area for user A”.

In a case where the exclusive area is set, the display control unit 113 distinguishably displays the exclusive area and an area other than the exclusive area in the document 40. FIG. 2A shows an example in which a frame of the sticky note 41a after being set as the exclusive area is displayed with a thick line. Accordingly, the user A can confirm that the sticky note 41a is set as the exclusive area dedicated to the user A. Then, the user A exclusively edits the sticky note 41a.

On the other hand, FIG. 2B shows an example of displaying the edit screen in a case where the user B displays the document 40 on the terminal B after the exclusive area is set by the user A for the sticky note 41a. As shown in the screen display example, the display is distinguishably made such that the sticky note 41a is known to be the exclusive area of another user. That is, in FIG. 2B, the sticky note 41a is displayed in gray out (hereinafter, simply referred to as “display in gray”). Accordingly, the user B knows from the display screen of the terminal B that the sticky note 41a is exclusively used by another user and cannot be edited by the user B. In other words, the user B can recognize that an area other than the sticky note 41a in the document 40 is an editable area.

In a case where the user B performs the predetermined operation, for example, the right-clicking on the exclusive area or selects “information display” included in the shortcut menu displayed by the right-clicking, the application execution control unit 11 may display, in association with the exclusive area, detailed information about the exclusive area selected by the user B, for example, a name of the user who exclusively uses the exclusive area, a setting start time of the exclusive area, and a scheduled setting cancel time of the exclusive area in a case where the setting is made.

FIG. 2B shows the screen display example after the exclusive area is set by the user A. For example, in a case where the document 40 is displayed on the terminal B before the exclusive area is set by the user A and then the user A sets the sticky note 41a as the exclusive area, the display example shown in FIG. 2B is also displayed on the terminal B. That is, in a case where the application execution control unit 11 receives the operation of using the sticky note 41a as the exclusive area from the terminal A, the exclusive area setting unit 111 displays the exclusive area (that is, sticky note 41a) on the terminal B in gray as the exclusive area for the user A.

Here, the document 40 is displayed in the case of two users A and B. However, the user B merely represents a user other than the user A who sets the exclusive area. That is, the display content of the edit screen displayed on the user terminal apparatus 30 used by other users n (n=B, C, D, . . . ) is the same as the display content of the terminal B.

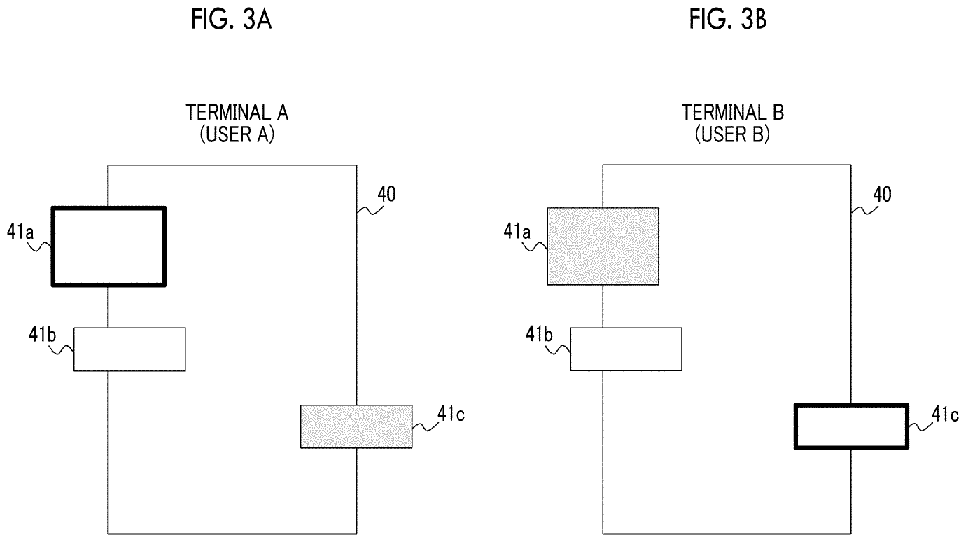

FIGS. 3A and 3B are diagrams showing an example of the edit screen displayed on each of the user terminal apparatuses 20 and 30 and are diagrams following FIGS. 2A and 2B. As described above, the area other than the sticky note 41a in the document 40 is the editable area for the user B. In a case where the user B wants to edit the description content of a sticky note 41c, the user B designates the sticky note 41c to be edited by the predetermined operation using the predetermined designation method described above. That is, the area designated as the edit range by the user B is equal to the display area of the sticky note 41c.

In a case where the application execution control unit 11 in the document management server 10 receives the edit area, that is, the area specified by the sticky note 41c from the user B in response to the predetermined operation, the exclusive area setting unit 111 sets the designated area (that is, sticky note 41c) as the exclusive area that is not editable by the user other than user B, that is, an exclusive area for user B. Of course, since the exclusive area is an area monopolized by one user. Therefore, the exclusive area setting unit 111 confirms in advance a setting situation of the exclusive area for the document 40 and determines whether or not the exclusive area can be set. In a case where the exclusive area is set, the display control unit 113 displays a frame of the sticky note 41c with a thick line as shown in FIG. 3B. Accordingly, the user B can confirm that the sticky note 41c is set as the exclusive area dedicated to the user B. Then, the user B can exclusively edit the sticky note 41c.

On the other hand, in a case where the exclusive area is set by the user B, the display control unit 113 displays the sticky note 41c in gray as shown in FIG. 3A.

In the above example, the range of the exclusive area is displayed with a thick line or displayed in gray in order to distinguishably display the exclusive area dedicated to one user and the exclusive area dedicated to another user from other areas. The above display form is an example, and there is no need to limit the present invention to this display example.

According to the present exemplary embodiment, as described above, since the user can partially and exclusively use one document, a plurality of users can edit one document in parallel at the same time. In this case, since the area to be edited by each person is set as the exclusive area by an editor, there is no edit conflict.

In the above description, the case where the sticky note 41 already attached to the document 40 is edited is described as an example. However, adding the sticky note 41 newly to the document is not considered as the edit of the sticky note 41. That is, the users A and B can newly add the sticky note 41 to the document 40.

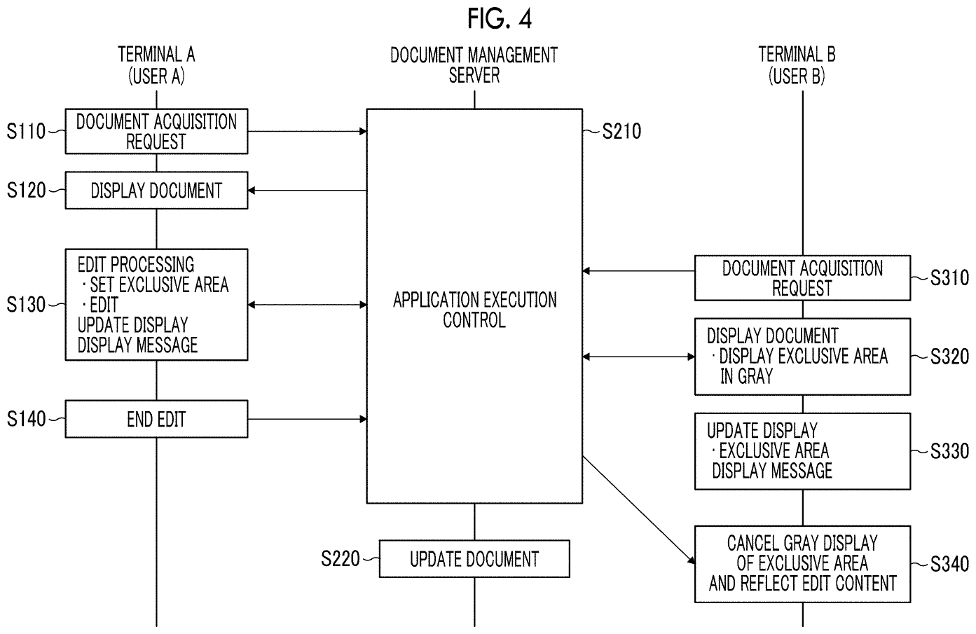

FIG. 4 is a sequence diagram showing the exchange of data and an instruction or a request in a case where the edit is performed between the document management server 10 and the terminals A and B described above. In a case where the document is edited, the document management server 10 exchanges information and the like with the terminals A and B in response to the operations of the users A and B. Therefore, the order of the processing executed by the application execution control unit 11 depends on the operations or the like of the users A and B and thus cannot be uniquely specified. Therefore, FIG. 4 comprehensively illustrates the processing executed by the application execution control unit 11 as application execution control processing (step S210). FIG. 4 mostly corresponds to the processing described with reference to FIGS. 2A and 2B, in which the user A is the editor of the document 40 and the user B is the browser of the same document 40.

In a case where the user A wants to perform the edit, the user A activates a predetermined application. Accordingly, the application execution unit 21 starts the operation. In a case where the user A designates the document to be edited, the application execution unit 21 transmits an acquisition request of the designated document to the document management server 10 (step S110).

The document management server 10 reads out the designated document from the document storage unit 12 in response to the document acquisition request from the terminal A and transmits the document to the terminal A. Accordingly, the application execution unit 21 displays the document acquired from the document management server 10 on the edit screen under the control of the display control unit 113 (step S120).

As described above, the user A edits the document (step S130). Specifically, the application execution control unit 11 updates, in cooperation with the application execution unit 21 of the terminal A, the display content of the edit screen on the terminal A according to the setting of the exclusive area, the edit of the exclusive area, the setting of the exclusive area by the user who edits an identical document (here, the user B), or the like (step S130). The display of the message will be described below.

For example, in a case where the user A performs the predetermined operation to set the sticky note 41a as the exclusive area as described above, the application execution control unit 11 allows only the user A to exclusively edit the sticky note 41a. With the setting of the exclusive area, the user other than the user A cannot edit the sticky note 41a. The information about the setting of the exclusive area and the cancellation of the setting is stored in the document storage unit 12.

On the other hand, in a case where the user B wants to browse or edit the document being edited by the user A, the user B activates the predetermined application. Accordingly, the application execution unit 31 starts the operation. In a case where the user B designates the document to be processed, the application execution unit 31 transmits the acquisition request of the designated document to the document management server 10 (step S310).

The document management server 10 reads out the designated document from the document storage unit 12 and transmits the document to the terminal B in response to the document acquisition request from the terminal B. Accordingly, the application execution unit 31 displays the document acquired from the document management server 10 on the edit screen under the control of the display control unit 113 (step S320). In this case, in a case where the exclusive area is set by the user A for the displayed document, the application execution control unit 11 displays the set exclusive area in gray as exemplified in FIG. 2B.

In a case where a part of the document is set as the exclusive area by the user A when the document is displayed on the terminal B, the application execution control unit 11 displays the set exclusive area for the user A in gray according to the setting of the exclusive area (step S330). The display of the message will be described below.

Thereafter, in a case where the user A ends the edit of the document, the application execution control unit 11 cancels the setting of the exclusive area for the user A. The application execution control unit 11 updates the document stored in the document storage unit 12 with the content of the edit performed on the exclusive area (step S220). The application execution control unit 11 stops the gray display of the exclusive area for the user A displayed in gray to return the display to a normal display form and reflects the edit by the user A for the exclusive area in the document displayed on the terminal B (step S340).

The case where the user B performs the edit is not included in FIG. 4, but the same processing as the case where the user A performs the edit is performed in the terminal B as the processing. That is, the same processing as in steps 130 and 140 in the terminal A is performed in the terminal B, and the same processing as in steps 320, 330, and 340 in the terminal B is performed in the terminal A.

As described above, the user B cannot edit the exclusive area for the user A, for example, the sticky note 41a shown in FIGS. 2A and 2B. However, movement of the sticky note 41a in the document 40 by the user B is allowed as not corresponding to the edit of the sticky note 41a. After the setting of the exclusive area of the sticky note 41a by another user is canceled, another user, for example, the user B, can set the sticky note 41a as the exclusive area of the user B to perform the edit.

Here, the display of the message will be described.

Regarding the setting of the exclusive area, in the above description, the notification is made that the exclusive area is set by another user by making the display form of the exclusive area different from the others. However, in a case where the exclusive area is set by another user, notification may be made in a text format that there is a disadvantage or the like for the user due to the setting of the exclusive area, in addition to the simple change in the display form for the area that is newly designated as the exclusive area. For example, a message such as “Sticky note a is locked by user A. You cannot edit sticky note until user A unlocks sticky note a.” may be displayed. Being set as the exclusive area is synonymous with being locked. A display position of the message may be, for example, near the exclusive area, or the message may be displayed on a specific message display area provided on the screen. A display time of the message may be determined as appropriate. In a case where the message is displayed for a long time, the display may interfere with edit or browsing. Therefore, for example, the display is desirable to be deleted automatically after a few seconds from the start of the display.

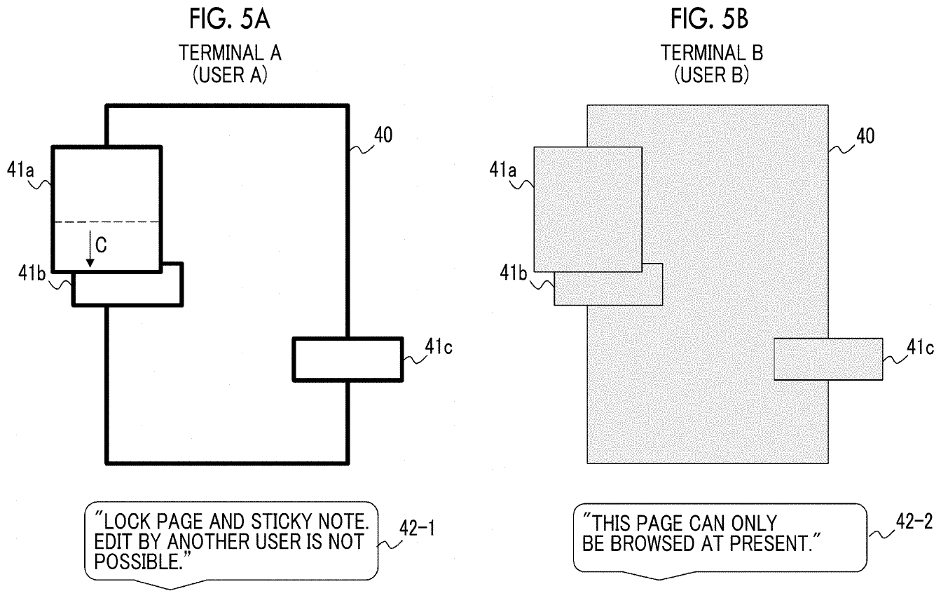

FIGS. 5A and 5B are diagrams showing an example of the edit screen displayed on the user terminal apparatuses 20 and 30 and are diagrams following FIGS. 2A and 2B. In the screen display example of FIGS. 5A and 5B and subsequent figures, an example of the displayed message is also illustrated.

With addition to the sticky note 41a due to the edit by the user A, a size of the sticky note 41a is assumed to be larger so as to overlap the sticky note 41b as indicated by an arrow C in FIG. 5A. As described above, the fact that the sticky note 41a overlaps the sticky note 41b due to the edit is considered to affect the document 40 to which the sticky note 41a is attached, and the application execution control unit 11 sets the entire document 40 as a new exclusive area of the user A.

Accordingly, in the terminal B displaying the document 40, the application execution control unit 11 sets the entire document 40 as the exclusive area for the user A and displays the entire document 40 in gray as shown in FIG. 5B. In other words, the edit of the document 40 cannot be performed even on the edit screen and only the browsing thereof is possible. Here, an example in which the document is composed of one page is described. However, in a case where the document is composed of a plurality of pages, the application execution control unit 11 automatically sets only a page for which the exclusive area is set, only the page to which the sticky note 41 is attached in the example shown in FIGS. 5A and 5B, as the exclusive area for the user A and does not set other pages as the exclusive area for the user A. That is, another user can edit pages other than the page to which the sticky note 41 is attached. As described above, the exclusive area may be set for each area affected by editing the exclusive area, that is, for each page as in this example. In the example shown in FIGS. 5A and 5B, the application execution control unit 11 automatically sets the entire page to which the sticky note 41a is attached as the new exclusive area for the user A. In the example of FIGS. 5A and 5B, the entire page is automatically set as the new exclusive area, but a partial area of the document 40 on which the sticky note 41a is applied may be automatically set as the exclusive area, instead of the entire page.

In a case where the sticky note 41a overlaps the sticky note 41b due to the edit, the application execution control unit 11 automatically sets the entire document as the exclusive area for the user A. Therefore, the application execution control unit 11 causes the terminal A to display the fact, for example, a message 42-1 such as “Lock page and sticky note. Edit by another user is not possible.” to notify the user A that the entire document is automatically set as the exclusive area.

By the way, in a case where an event occurs in which the edit of the sticky note 41a matches a condition for setting the entire document as the exclusive area as described above, that is, in a case where the sticky note 41a overlaps the sticky note 41b according to the above example, the application execution control unit 11 may automatically set the entire document as the exclusive area for the user A after a predetermined time elapses from displaying the above message on the screen of the terminal A, not immediately after the sticky note 41a overlaps the sticky note 41b.

On the other hand, in a case where the entire document 40 is set as the exclusive area for the user A, the application execution control unit 11 causes the terminal B to display, for example, a message 42-2 such as “This page can only be browsed at present.” to notify the user B that the document 40 is browsed only and cannot be edited. As described above, the user who displays the document on the edit screen by displaying the message can be notified of a current situation of the user.

In the present exemplary embodiment, the area affected by editing the exclusive area is set as the new exclusive area. In the example shown in FIGS. 5A and 5B, the sticky note 41b is affected by a positional relationship with the sticky note 41a, which is the exclusive area. That is, the sticky note 41b cannot be browsed. However, the presence or absence of influence is not limited to the positional relationship of the area. For example, the presence or absence of influence may depend on the description content in the additional area. For example, in a case where a table of contents in the document is set as the exclusive area and the edit of the table of contents is performed, the application execution control unit 11 may analyze the content of the edited table of contents, consider that there is a high possibility that a page containing a chapter or a section that is relevant in content is also edited, and automatically set the page as the exclusive area.

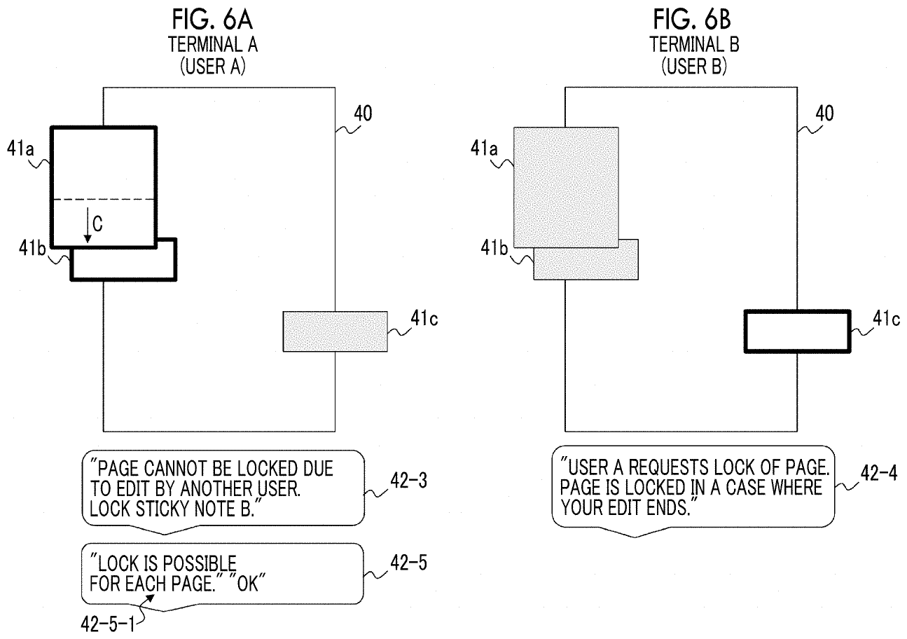

FIGS. 6A and 6B are diagrams showing an example of the edit screen displayed on the user terminal apparatuses 20 and 30 and are diagrams showing an example of screens displayed following FIGS. 3A and 3B. In FIGS. 6A and 6B, with addition to the sticky note 41a due to the edit by the user A, the size of the sticky note 41a is assumed to be larger so as to overlap the sticky note 41b as indicated by the arrow C in FIG. 6A, as in FIGS. 5A and 5B. However, in FIGS. 6A and 6B, the fact that the sticky note 41a overlaps the sticky note 41b due to the edit is considered that the sticky note 41a affects the sticky note 41b, and the application execution control unit 11 sets only the sticky note 41b as the new exclusive area of the user A, different from the case of FIGS. 5A and 5B.

Alternatively, as the processing flow, the application execution control unit 11 may try to set the entire document 40 as the new exclusive area of the user A in FIG. 6 as in FIGS. 5A and 5B. However, in this case, since the sticky note 41c is the exclusive area for the user B, the application execution control unit 11 cannot set the sticky note 41c as the exclusive area for the user A unless the user B cancels the setting of the exclusive area. That is, the entire document 40 cannot be set as the exclusive area for user A. The application execution control unit 11 may set only the sticky note 41b, which is directly affected by the sticky note 41a, as the new exclusive area of the user A.

In a case where the sticky note 41a overlaps the sticky note 41b due to the edit, the application execution control unit 11 tries to set the entire document as the exclusive area for the user A. However, the entire document cannot be set as the exclusive area for the user A due to the existence of the sticky note 41c as described above. The application execution control unit 11 causes the terminal A to display the fact, for example, a message 42-3 such as “Page cannot be locked due to edit by another user. Lock sticky note b.” to notify the user A that only the sticky note 41b is additionally set as the exclusive area for the user A.

On the other hand, in a case where only the sticky note 41b is additionally set as the exclusive area for the user A, the application execution control unit 11 causes the terminal B to display, for example, a message 42-4 such as “User A requests lock of page. Page is locked in a case where your edit ends”. Accordingly, in a case where the user B ends the edit of the sticky note 41c, the user B is notified that the entire document 40 is set as the exclusive area for the user A. The application execution control unit 11 records that the entire document 40 cannot be set as the exclusive area. Thereafter, in a case where the user B ends the edit of the sticky note 41c and the exclusive area is canceled, the application execution control unit 11 causes the terminal A to display, for example, a message 42-5 such as “Lock is possible for each page”. The message 42-5 includes an OK button 42-5-1 for instructing the user A whether or not to perform the setting as the exclusive area for each page. The application execution control unit 11 may change the setting of the exclusive area from only the sticky note 41b to the entire document in response to the selection of the OK button 42-5-1 by the user A. Alternatively, the setting of the exclusive area to the entire document may be unconditionally switched.

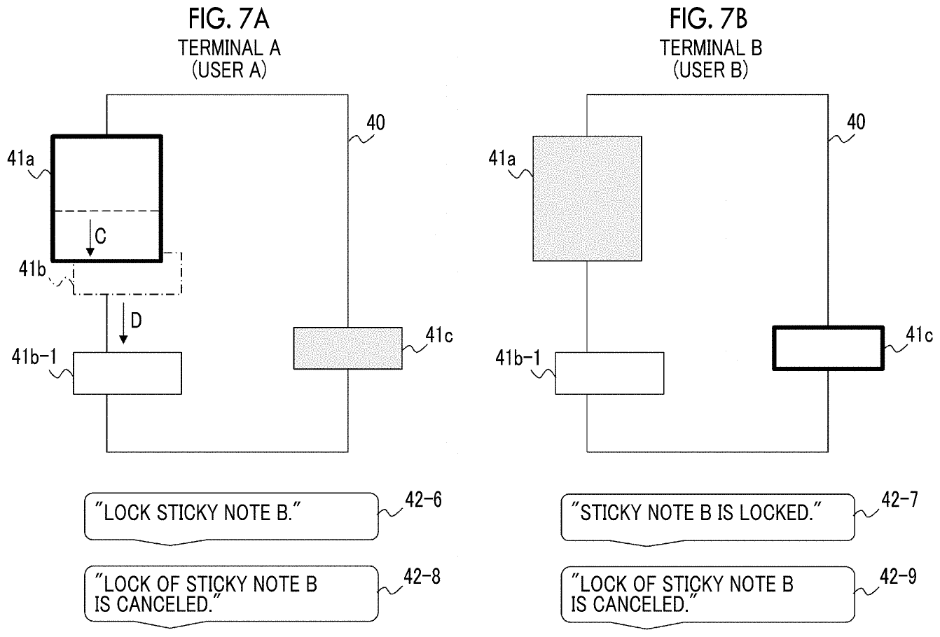

FIGS. 7A and 7B are diagrams showing an example of the edit screen displayed on the user terminal apparatuses 20 and 30 and are diagrams showing an example of screens displayed following FIGS. 6A and 6B.

In FIGS. 6A and 6B, in a case where the sticky note 41a overlaps the sticky note 41b due to the edit, the application execution control unit 11 automatically sets the sticky note 41b as the exclusive area for the user A. In FIG. 7, the user A then moves the sticky note 41b, which overlaps with the sticky note 41a, to a position where the sticky note 41b does not overlap with the sticky note 41a, as indicated by an arrow D. That is, in a case where the sticky note 41b out of the sticky notes 41a and 41b, which are the exclusive areas in the document 40, is moved to the outside of the exclusive area, the sticky note 41a does not affect a moved sticky note 41b-1. Therefore, there is no need to set the sticky note 41b-1 as the exclusive area for the user A. Therefore, the application execution control unit 11 cancels the setting of the exclusive area for the sticky note 41b-1 after the movement according to the movement of the sticky note 41b automatically set as the exclusive area.

In a case where the sticky note 41a is moved to a position where the sticky note 41a does not overlap with the sticky note 41b, the moved sticky note 41a does not affect the sticky note 41b. Therefore, the application execution control unit 11 cancels the setting of the exclusive area for the sticky note 41b. Even in a case where the sticky note 41a is moved, the user A manually sets the sticky note 41a as the exclusive area. Therefore, the application execution control unit 11 does not cancel the setting of the exclusive area for the sticky note 41a.

As the sticky note 41b is moved to the position of the sticky note 41b-1 on the terminal A, the application execution control unit 11 moves the sticky note 41b to a position of the sticky note 41b-1 in the document 40 displayed on the terminal B in the same manner as the terminal A. With the cancellation of the setting of the exclusive area for the sticky note 41b-1, the application execution control unit 11 changes the display form of the sticky note 41b-1 from the exclusive area to an editable normal area.

In a case where the sticky note 41a overlaps the sticky note 41b due to the edit, the application execution control unit 11 sets the sticky note 41b as the exclusive area for the user A. Therefore, the application execution control unit 11 causes the terminal A to display the fact, for example, a message 42-6 such as “Lock sticky note b.” to notify the user A that only the sticky note 41b is additionally set as the exclusive area for the user A.

On the other hand, in a case where only the sticky note 41b is additionally set as the exclusive area for the user A, the application execution control unit 11 causes the terminal B to display, for example, a message 42-7 such as “Sticky note b is locked”.

Thereafter, in a case where the user A moves the sticky note 41b to the position of the sticky note 41-b, there is no need to maintain the sticky note 41b-1 as the exclusive area as described above. Therefore, the application execution control unit 11 causes the terminal A to display the fact, for example, a message 42-8 such as “Lock of sticky note b is canceled.” to notify the user A that the setting of the exclusive area for the sticky note 41b is canceled.

On the other hand, in a case where the setting of the exclusive area for the sticky note 41b-1 is canceled, the application execution control unit 11 causes the terminal B to display, for example, a message 42-9 such as “Lock of sticky note b is canceled”.

In the description using FIGS. 7A and 7B, the sticky note 41b is once set as the exclusive area for the user A as shown in FIGS. 6A and 6B and then the setting is canceled with the movement to the sticky note 41b-1. However, in the description of FIGS. 5A and 5B, the automatic setting of the exclusive area for the user A may be performed after the predetermined time elapses, not immediately after the sticky note 41a overlaps the sticky note 41b. Therefore, also in FIGS. 7A and 7B, in a case where the user A moves the sticky note 41b to a position not affected by the sticky note 41a before the predetermined time elapses, instead of setting the sticky note 41b as the exclusive area for the user A immediately after the sticky note 41a overlaps the sticky note 41b, the sticky note 41b may not be set as the exclusive area for the user A. In this case, the setting or the cancellation of the setting of the exclusive area for the sticky note 41b is not performed. Therefore, there is no need to display the messages 42-6 to 42-9 shown in FIGS. 7A and 7B on the terminals A and B.

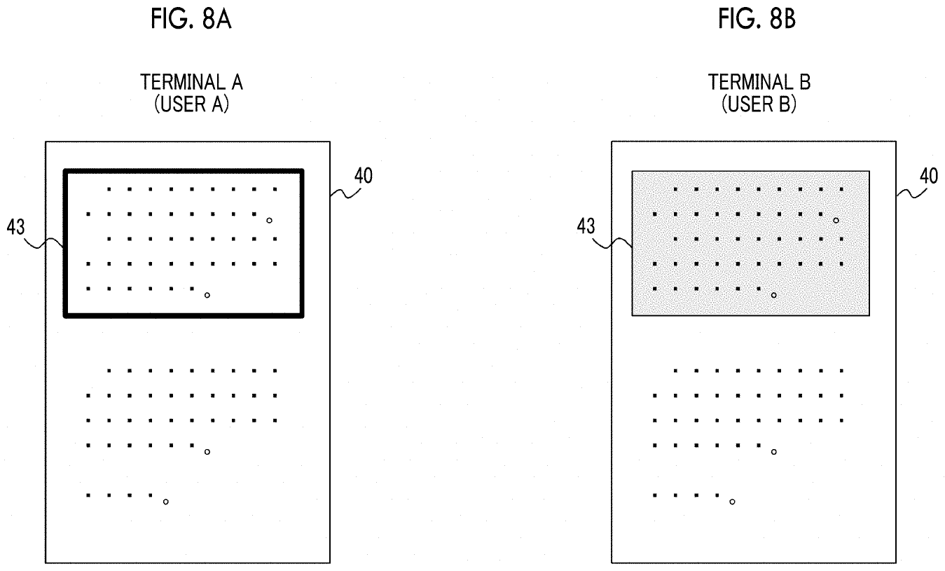

FIGS. 8A and 8B are diagrams showing another example relating to the setting of the exclusive area. The exclusive areas set in FIGS. 2, 3, 5 to 7 are the areas specified by the sticky note 41. FIGS. 8A and 8B shows an example in which the exclusive area is set in an area other than the additional area, that is, a main body portion of the document 40. The sticky note 41 used in the above description is omitted from the figure for convenience.

In the above description, the sticky note 41 is selected to designate the area to be edited. Here, the user A designates a partial area constituting the main body of the displayed document 40 as the area to be edited. For example, the terminal A displays a setting button for the exclusive area (not shown). In a case where the user A selects the setting button for the exclusive area and then designates a range with a mouse cursor, text selection, or the like, the application execution control unit 11 sets the designated range as the exclusive area. FIG. 8A shows an example in which a range surrounded by the user A is set as an exclusive area 43. A frame of the exclusive area 43 indicating the range is displayed with a thick line, as in the case of the sticky note 41.

On the other hand, on the terminal B, in a case where the exclusive area 43 of another user is set in the document 40 to be displayed or the document 40 being displayed, the exclusive area 43 is displayed in gray as shown in FIG. 8B.

By the way, in the above description, the case where the document is mostly composed of one page is described. However, the document is often composed of a plurality of pages in reality. In the following description, the display in a case where the document is composed of the plurality of pages will be described.

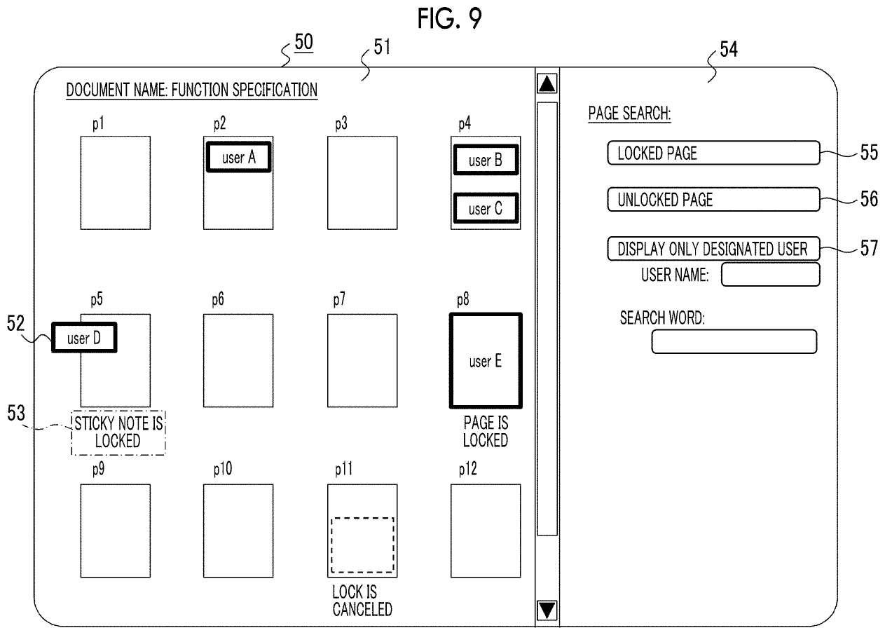

FIG. 9 is a diagram showing an example of a display screen for displaying a list of a plurality of pages constituting a document. As exemplified in FIG. 9, a list display area 51 of the pages provided on a left side of a list display screen 50 includes a document name of the document to be displayed and a state of each page constituting the document, particularly a setting state of the exclusive area. Specifically, in FIG. 9, an exclusive area 52 is indicated by a thick line frame. As information for identifying the user who exclusively uses the exclusive area 52, the user name is shown inside the exclusive area 52. The display regarding the exclusive person is not limited to this example, and may be displayed in association with the vicinity of the exclusive area 52, for example. The display regarding the exclusive person may be shown by an image such as a face photograph of the user or an avatar instead of a text string such as the user name. A type of information to be displayed may be determined as appropriate.

Each page is provided with an information display area 53 in association with the page. FIG. 9 shows an example in which the information display area 53 is displayed in association with a lower part of a display position of the page. In the information display area 53, information about the page is displayed in a text format. Examples of the information to be displayed include information about the transition of the setting of the exclusive area such as the setting or canceling of the exclusive area by another user within a predetermined time, information indicating the area in which the exclusive area is set, and information about a reservation described below.

A search area 54 is provided in an area on a right side of the list display screen 50. In the list display area 51, the pages constituting the document are listed in the order of page numbers as an initial setting. The user can narrow down the pages to be displayed in the list display area 51 according to a requested narrowing condition by selecting buttons 55 to 57 provided in the search area 54 or inputting predetermined items. In the present exemplary embodiment, the “locked page” button 55 for narrowing down to the page for which the exclusive area is set, the “unlocked page” button 56 for narrowing down to the page for which the exclusive area is not set, and the “display only designated user” button 57 for narrowing down by the user who sets the exclusive area are exemplified. Of course, a button with another condition as the narrowing condition may be provided.

In a case where a predetermined operation, for example, double-clicking is performed on the page displayed in the list display area 51, the transition to the edit screen shown in FIGS. 2A and 2B and the like may be possible.

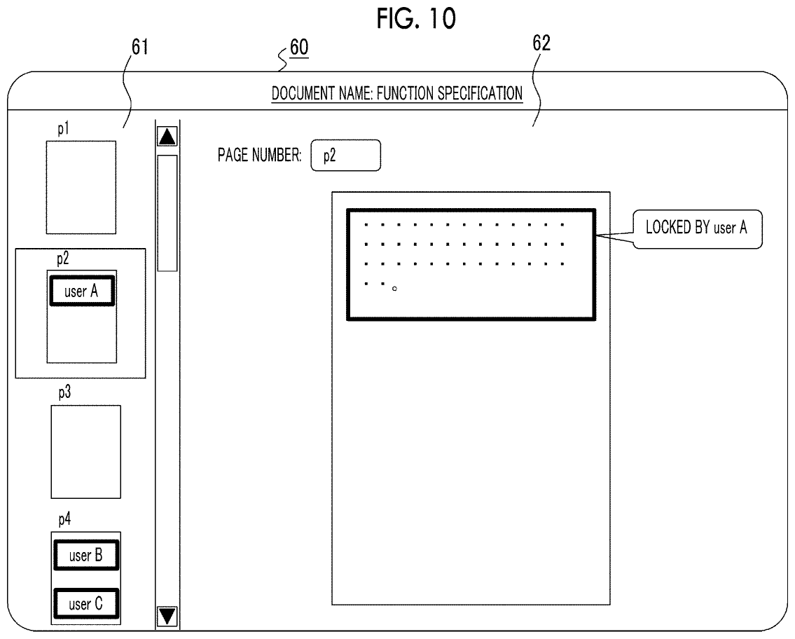

FIG. 10 is a diagram showing another example of a display screen for displaying a list of the plurality of pages constituting the document. As exemplified in FIG. 10, in a list display area 61 provided on a left side of a list display screen 60, the pages constituting the document are displayed in a vertical row in the order of page numbers. An edit area 62 is provided on a right side of the list display screen 60. The edit area 62 corresponds to the edit screen shown in FIGS. 2A and 2B and the like. In a case where the user selects a page to be edited from the list display area 61, the application execution control unit 11 displays the selected page in the edit area 62. Of course, in a case where another user sets the entire page as the exclusive area, only browsing is possible and the page cannot be edited from the edit area 62.

As described above, the exclusive area set for the edit by the user is set within a range requested by the user in the document. Therefore, addition or deletion of the page to the document is possible. However, regarding the deletion of the page, the page is not unconditionally and immediately deleted even in a case where a deletion instruction is issued. That is, the application execution control unit 11 confirms whether or not the exclusive area is set for the page. In a case where the exclusive area is set for the page, the page is deleted after the setting is canceled. That is, in a case where a deletion operation is performed on the page set as the exclusive area, the application execution control unit 11 notifies the user who performed the deletion operation that the page cannot be deleted immediately. The user is allowed to select whether to delete the page or reserve the deletion. In the former case, the user occasionally performs the deletion operation again. In the latter case, the application execution control unit 11 receives the reservation for the deletion of the page and deletes the page as soon as the setting of the exclusive area for the page is canceled. In a case where the exclusive area is not set on the page to be deleted, the page can be deleted immediately.

Here, the deletion of the page can be reserved. The edit may be reserved in the same manner. For example, in FIG. 9, in a case where the page to be edited or a part of the page is set as the exclusive area by another user, the edit of the area may be reserved. As the reservation, the setting of the exclusive area may be reserved. In this case, in a case where the edit by another user ends, the application execution control unit 11 notifies a reservation person of the end of the edit. The reservation person who receives the notification can set the exclusive area for the area with priority. Therefore, the reservation person sets the area as the exclusive area of the reservation person and then performs the edit. Alternatively, in a case where the edit content for the area is registered in advance and the setting of the exclusive area by another user is unlocked, the application execution control unit 11 may reflect the reserved edit content in the area.

The application execution control unit 11 sets and registers, in the document storage unit 12, information about the reservation, for example, information for specifying an area to be edited or a page to be deleted and reservation information including a reservation person, a reservation date and time, and the like in association with the page. The reservation may be canceled by the reservation person. The application execution control unit 11 may display the reservation information in the information display area 53 shown in FIG. 9. The information about the deleted page may be displayed on the list display screens 50 and 60.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
receive an area in a document from a first user; and
set in the received area an exclusive area that is not editable by a user other than the first user.

2. The information processing apparatus according to claim 1,
wherein the area is a partial area constituting the document or an additional area for displaying additional information to the document.

3. The information processing apparatus according to claim 1, wherein the processor is configured to:
distinguishably display the exclusive area and an area other than the exclusive area in the document.

4. The information processing apparatus according to claim 1, wherein the processor is configured to:
set an area affected by editing the exclusive area as a new exclusive area.

5. The information processing apparatus according to claim 4,
wherein the area affected by editing the exclusive area is a page for which an exclusive area is set in a case where the document is composed of a plurality of pages, or an additional area for displaying additional information to the document in a case where the additional area is provided on the page.

6. The information processing apparatus according to claim 1, wherein the processor is configured to:
cancel, in a case where an additional area for displaying additional information to the document is moved from the exclusive area to a position outside the exclusive area, non-editability of the additional area by a user other than the first user.

7. The information processing apparatus according to claim 1, wherein the processor is configured to:
preform control to display a notification relating to the setting of the exclusive area or cancellation of the setting of the exclusive area.

8. The information processing apparatus according to claim 1, wherein the processor is configured to:
preform control to display a setting state of the area on a list display screen of pages of the document.

9. The information processing apparatus according to claim 8, wherein the processor is configured to:
preform control to display information about a transition of the setting of the exclusive area for each page on the list display screen in correspondence with the page.

10. The information processing apparatus according to claim 8, wherein the processor is configured to:
narrow down the pages to be displayed on the list display screen from among the pages constituting the document according to a page for which the exclusive area is set, a page for which the exclusive area is not set, or a user who has set the exclusive area.

11. The information processing apparatus according to claim 1, wherein the processor is configured to:
receive a reservation for an edit on the exclusive area, and
reflect the reserved edit in the exclusive area in a case where the exclusive area becomes editable.

12. A non-transitory computer readable medium storing a program causing a computer to realize a function comprising:
receiving an area in a document from a first user; and
setting in the received area an exclusive area that is not editable by a user other than the first user.

13. An information processing method comprising:
receiving an area in a document from a first user; and
setting in the received area an exclusive area that is not editable by a user other than the first user.
